(19) United States
(12) Patent Application Publication
(10) Pub. No.: US 2021/0387543 A1
(43) Pub. Date: Dec. 16, 2021

(54) COMMUNICATION SYSTEM AND COMMUNICATION CONTROL METHOD

(71) Applicant: Yazaki Corporation, Tokyo (JP)

(72) Inventor: Jin WATANABE, Makinohara-shi (JP)

(73) Assignee: Yazaki Corporation, Tokyo (JP)

(21) Appl. No.: 17/345,247

(22) Filed: Jun. 11, 2021

(30) Foreign Application Priority Data
Jun. 12, 2020 (JP) 2020-102373

(51) Int. Cl. B60L 53/66; B60L 53/56; B60L 53/30; B60L 53/65; G07F 15/00

(52) U.S. Cl. CPC B60L 53/665; B60L 53/56; B60L 53/305; G06Q 50/30; G07F 15/005; B60Y 2200/91; B60L 53/65

(57) ABSTRACT

A communicable charging facility, a management server, and a payment terminal installed in a store or the like are provided. The management server manages information indicating correspondence between a member's vehicle ID and a user ID, and when the user performs a vehicle charging operation at the charging facility, the charging facility acquires the vehicle ID transmitted by the vehicle and transmits it to the management server. The management server allows the charging facility to start charging when user authentication is successful based on the vehicle ID received from the charging facility and management information. The charging facility transmits a charge authentication ID to a target vehicle or a mobile terminal of the corresponding user after the start of charging. When payment of a fee of the user's product is performed on the payment terminal, the payment terminal or the management server acquires the charge authentication ID transmitted from the user's mobile terminal and the management server identifies charging history and the like.

### CROSS REFERENCE TO RELATED APPLICATIONS

This application is based on and claims priority from Japanese patent application No. 2020-102373 filed on Jun. 12, 2020, the entire contents of which are incorporated herein by reference.

### TECHNICAL FIELD

The present invention relates to a communication system and a communication control method which can be used to manage consumption behavior associated with a charging operation by a user who uses an electric vehicle (EV), a plug-in hybrid vehicle (PHV), or the like.

### BACKGROUND ART

A typical electric vehicle has a short mileage when fully charged and tends to take an extremely long time to charge unless a dedicated rapid charging facility is used. Therefore, it is necessary to perform a charging work frequently. The same tendency applies to a plug-in hybrid vehicle. Therefore, an electric vehicle and a plug-in hybrid vehicle are configured so that not only a charging station equipped with a dedicated rapid charging facility but also a power plug socket installed in each home and a charging facility installed in various places can be used.

It is assumed that the charging facility for the vehicle as described above are installed in a parking lot of a shop such as a service area parking lot on highways and a convenience store in various places. When such a charging facility can be used anywhere, it will be more convenient for a vehicle user and it is expected that a supply rate of an electric vehicle and a plug-in hybrid vehicle will increase.

However, in order to install a charging facility for a vehicle, it is necessary to secure a large and dedicated space and it is also necessary to bear the cost of equipment and maintenance. Therefore, it is important for a business operator who has installed the charging facility to operate the charging facility efficiently and find added value.

A vehicle network advertising system of JP-A-2007-68164 shows a technique for providing an improved architecture for situation-aware advertising and distribution between mobile communication devices. Specifically, the system includes a navigation module 580 which provides map data for a vehicle on the network and a situational awareness module 540 which interprets data provided by a sensor in the vehicle. The advertisement data is received by a data receiving module 570. A configuration module 530 determines availability of presentation slots. The value and content of authenticated advertisement are confirmed by an advertisement management module 520 and selected advertisement is presented to a vehicle user.

A power supply system of JP-A-2018-45304 shows a technique for discriminating a person who intends to receive power supply using a household power plug socket, a parking lot power plug socket, or the like and permitting power supply, and figure out an amount of power used. Specifically, the system is provided with a switch unit 14 which has unique identification information and turns on or off power supply to a power plug socket 13 in response to a request from a server 20, a power measuring unit 15 for measuring an amount of power supplied to a power supply target device, a mobile socket 10 including a socket-side communication unit 16 which communicates with the server 20, storage unit 22 capable of associating and recording user master information and a power consumption amount, an authentication unit 23 which authenticates identification information and user input information transmitted from a terminal 30 used by a user, an authentication processing unit 24 which sends an on or off command to the switch unit based on an authentication result, and a server-side communication unit 27 which communicates with each of the mobile socket 10 and the terminal 30.

A vehicle charging system of JP-A-2019-186814 shows a technique for reducing a workload of a user for authentication and improving convenience of the user. Specifically, the charging facility 1 includes an information display unit which displays authentication information and an authentication unit 31 which performs authentication using the authentication information. A vehicle 2 includes an image pickup device (rear camera 203 and front camera 204) and a communication device 201b which transmits authentication information acquired by the image pickup device to an authentication unit. The authentication unit 31 of a charging facility is configured to perform authentication using the authentication information received from the communication device 201b, and when the authentication is successful, permit the vehicle 2 to use a wireless LAN 301.

When the technique of JP-A-2007-68164 is used, the value and content of the authenticated advertisement are confirmed, and the selected advertisement is presented to the vehicle user. However, for example, it is not possible to distinguish between a user of a vehicle which has been charged using a specific charging facility and a user other than that.

A business operator of a store with the specific charging facility cannot figure out relationship between the user of the charged vehicle and a product purchased by the user at the store. The vehicle user cannot obtain special added value even when using both the charging facility and the store operated by a common business operator. Even when the techniques of JP-A-2018-45304 and JP-A-2019-186814 are used, the use of the charging facility cannot be associated with the use of other services.

According to the embodiment, the communication system and the communication control method are useful for managing the consumption behavior associated with the charging operation of the user who uses the electric vehicle or the like.

### SUMMARY OF INVENTION

According to a communication system of the embodiment, a charging facility which can be connected to a vehicle, a management server which can communicate with the charging facility, and a payment terminal which is installed in a store or the like related to the charging facility and can communicate with the management server.

The communication system includes a first function of managing first management information indicating correspondence between a vehicle ID assigned to each vehicle and a user ID assigned to each user who uses each vehicle by the management server,

a second function of acquiring the vehicle ID transmitted by the vehicle with the charging facility and transmitting it to the management server when a user of a vehicle performs a charging operation on the vehicle at the charging facility,

a third function of permitting start of charging of the charging facility when the management server succeeds in user authentication based on the vehicle ID received from the charging facility and the first management information,

a fourth function of transmitting a charge authentication ID to a vehicle to be charged or a mobile terminal owned by the corresponding user after the charging facility starts charging, and

a fifth function of identifying presence of at least charging history with the management server by acquiring the charge authentication ID transmitted from the mobile terminal of the corresponding user with the payment terminal or the management server when payment of a fee associated with a consumption behavior of each user is made on the payment terminal.

### BRIEF DESCRIPTION OF DRAWINGS

FIG. 1 is a block diagram illustrating a configuration example of a communication system according to an embodiment of the invention;

FIG. 2 is a block diagram illustrating an outline of a signal and electric power transmitted between charging facility and an in-vehicle device;

FIG. 3 is a time chart illustrating an example of a waveform of the signal and electric power transmitted between the charging facility and the in-vehicle device;

FIG. 4 is a sequence diagram illustrating an outline of operation of each part in the communication system of the embodiment;

FIG. 5 is a flowchart illustrating an operation of a management server at the time of charging and an operation associated therewith; and

FIG. 6 is a flowchart illustrating an operation example of a POS terminal when a product price is settled.

### DESCRIPTION OF EMBODIMENT

A specific embodiment of the invention will be described below with reference to the respective drawings.

### Configuration of Communication System

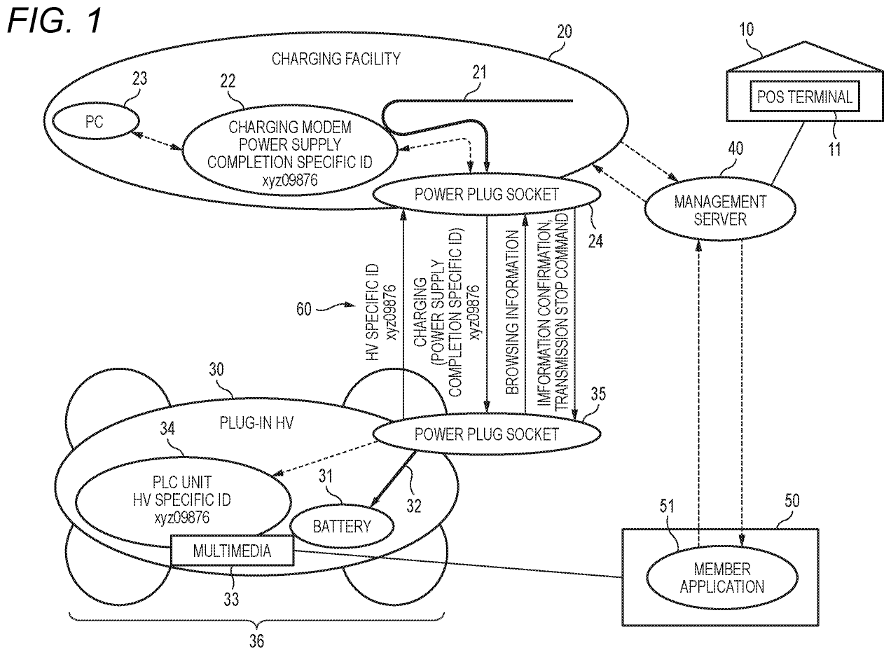

FIG. 1 illustrates a configuration example of a communication system according to the embodiment of the invention.

In the example illustrated in FIG. 1, it is assumed that a business operator operating a store 10 which sells products and the like simultaneously operates a charging facility 20 installed in a parking lot at a location adjacent to the store 10. Of course, it is possible to apply the invention in various other situations.

A point of sale system (POS) (Point-of-sale information management) terminal 11 which supports payment of electronic money is installed in the store 10 which sells products and the like. Therefore, a customer who purchases the product or the like can use the electronic money charged in an IC card dedicated to the electronic money, an IC card integrated with a credit card, an IC card mounted on a mobile terminal such as a smartphone, or the like to settle the product price.

The charging facility 20 is configured as a normal charger or a quick charger having a function of charging a vehicle 30 such as a plug-in hybrid vehicle and an electric vehicle. When the charging facility 20 is a normal charger, charging is performed in a state where a tip of a charging cable 60 mounted on the vehicle 30 is inserted into a power plug socket 24 of the charging facility 20.

The charging facility 20 includes a charger control unit 23 composed of a personal computer (PC) equipped with a function for controlling charging. A charging modem 22 is provided in the charging facility 20 for communication using a power line of the charging cable 60. The charging modem 22 has a communication function corresponding to power line communication (PLC). The charging modem 22 has a specific ID (for example, “xyz09876”) which identifies itself. The ID is used as a charge authentication ID (22a) for authenticating whether charging has been performed using the charging facility 20. The charger control unit 23 can transmit the charge authentication ID of the charging modem 22 to the vehicle 30 at the time of charging.

The vehicle 30 illustrated in FIG. 1 includes an in-vehicle battery 31, an in-vehicle control unit 33, a PLC unit 34, and a charging connector 35 as an in-vehicle device 36. The in-vehicle battery 31 has a sufficient storage capacity necessary for the vehicle 30 to travel. By connecting the power plug socket 24 of the charging facility 20 and the charging connector 35 of the vehicle 30 using the charging cable 60, charging power 32 can be supplied to the in-vehicle battery 31.

The PLC unit 34 having a PLC communication function of the communication standard common to the charging modem 22 is connected to a charging system power line in the vehicle 30. Therefore, when charging using the charging cable 60, data communication can be performed between the charging modem 22 and the PLC unit 34 via the power line of the charging cable 60. The PLC unit 34 has a vehicle ID (for example, “ABC12345”) which can be used to identify each vehicle 30. The in-vehicle control unit 33 can transmit the vehicle ID of the PLC unit 34 to the charging facility 20 at the time of charging.

The in-vehicle control unit 33 is an electronic control unit (ECU) equipped with a multimedia communication function and has a wireless communication function compatible with Wi-Fi (registered trademark) and a function of communicating using the PLC unit 34.

A management server 40 is arranged on the Internet and is connected to be able to communicate with the POS terminal 11 in the store 10 and the charger control unit 23 of the charging facility 20. Since the management server 40 is arranged on the Internet, the management server 40 can be accessed from a mobile terminal such as a smartphone 50 by wireless communication.

The management server 40 has a function of making a payment such as a customer's product purchase price based on information input from the POS terminal 11, a function to manage a charging operation in the charging facility 20, a function of managing information of each registered member, and the like.

The smartphone 50 owned by a user (driver or the like) of the vehicle 30 can communicate with the in-vehicle control unit 33 by using the wireless communication function corresponding to Wi-Fi. When a member application 51, which is application software prepared in advance for a user who uses the store 10 or the charging facility 20, is installed on the smartphone 50, the user can access the management server 40 on the Internet by using the member application 51 of the smartphone 50.

The user can register as a member by using the member application 51. The registered member information is managed by the management server 40. In the case of a member user registered in the management server 40, it becomes possible to use specific electronic money when purchasing a product at the store 10. It may be possible to use the charging facility 20 free of charge. It may be possible to obtain a discount coupon which can be used when paying for the purchase of goods at the store 10 or the like.

### Transmission between Charging Facility and In-vehicle Device

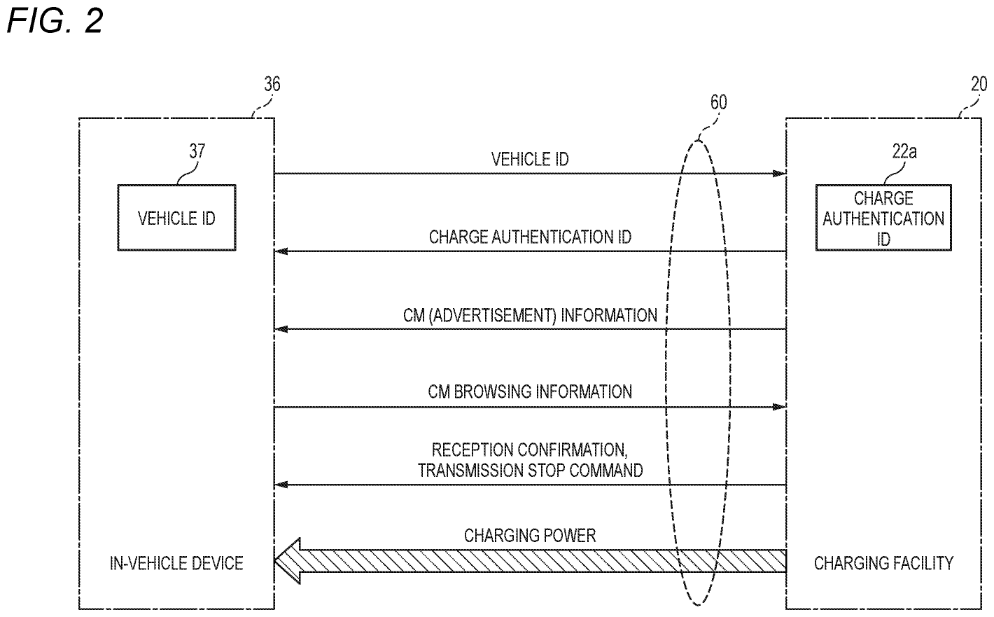

FIG. 2 illustrates an outline of the signal and power transmitted between the charging facility 20 and the in-vehicle device 36.

As illustrated in FIG. 1, in a state where the charging cable 60 is used to connect the charging connector 35 of the in-vehicle device 36 and the power plug socket 24 of the charging facility 20, the charging cable 60 can be used to perform communication as illustrated in FIG. 2 by power line communication. That is, the communication signal is bidirectionally transmitted as a digital modulation signal superimposed on the charging power supplied from the charging facility 20 to the in-vehicle device 36.

The in-vehicle device 36 can modulate the information of its own vehicle ID 37 held in advance by using the PLC unit 34, superimpose the information on the electric power, and transmit the information and electric power to the charging facility 20. The charger control unit 23 of the charging facility 20 can acquire the information of the vehicle ID 37 transmitted from the in-vehicle device 36 by extracting the information with the charging modem 22 and demodulating the information.

The charger control unit 23 of the charging facility 20 can modulate the charge authentication ID 22a assigned to the charging modem 22 by using the charging modem 22 and superimpose the ID on the electric power to transmit the ID to the in-vehicle device 36. The in-vehicle control unit 33 of the in-vehicle device 36 can acquire the information of the charge authentication ID 22a transmitted from the charging facility 20 by extracting the ID with the PLC unit 34 and demodulating the ID.

It is assumed that the time for charging the in-vehicle device 36 of the vehicle 30 by the electric power supplied by the charging facility 20 is usually relatively long. In order to effectively utilize the charging time as a sales promotion or the like, the charging facility 20 can deliver CM (advertising) information. The CM information is also transmitted from the charging modem 22 in a state of being superimposed on the electric power by the power line communication.

In the in-vehicle device 36, the PLC unit 34 extracts, demodulates, and acquires the CM information transmitted from the charging facility 20, and using a display of the in-vehicle control unit 33, for example, character information and moving images representing various products can be displayed so that the user can view such CM information. When the charging facility 20 collectively transmits a large amount of CM information, by user's input operation to the in-vehicle control unit 33, only the specific CM information that the user is interested in among a large number of CM information can be selectively displayed on the display of the in-vehicle control unit 33. Here, data representing specific CM information selected by the user is generated by the in-vehicle control unit 33 and is transmitted from the PLC unit 34 of the in-vehicle device 36 as CM browsing information.

The charger control unit 23 of the charging facility 20 can acquire the CM browsing information transmitted from the in-vehicle device 36 by extracting the information with the charging modem 22 and demodulating the information. After acquiring the CM browsing information, the charger control unit 23 of the charging facility 20 transmits a receipt confirmation notification indicating the acquisition and a transmission stop command to the in-vehicle device 36 using the charging modem 22.

### Waveform of Transmitted Signal and Power

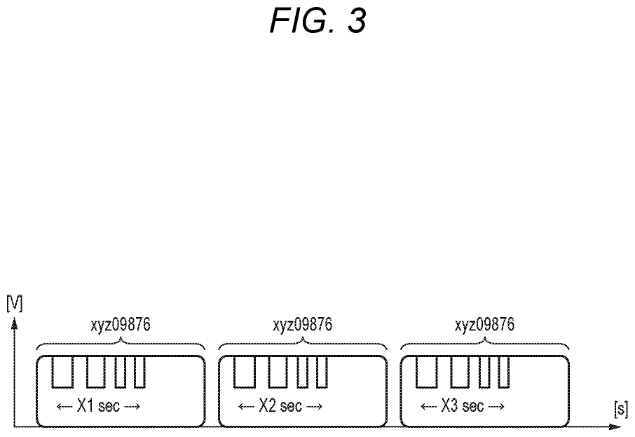

FIG. 3 illustrates an example of a waveform of a signal and electric power transmitted between the charging facility 20 and the in-vehicle device 36. In FIG. 3, a horizontal axis represents time [seconds] and a vertical axis represents voltage [V].

In the example illustrated in FIG. 3, packet-shaped DC power having a time width of X1, X2, and X3 [seconds] appears intermittently on the power line of the charging cable 60 and information codes of “xyz09876”, “xyz09876”, and “xyz09876” appear in order in a state of being superimposed on the respective packet-shaped DC power.

By repeating the transmission of the same information code a plurality of times (three times) using, for example, a plurality of power packets as illustrated in FIG. 3, it is possible to reliably transmit the correct information even when a transmission error occurs.

### System Operation Overview

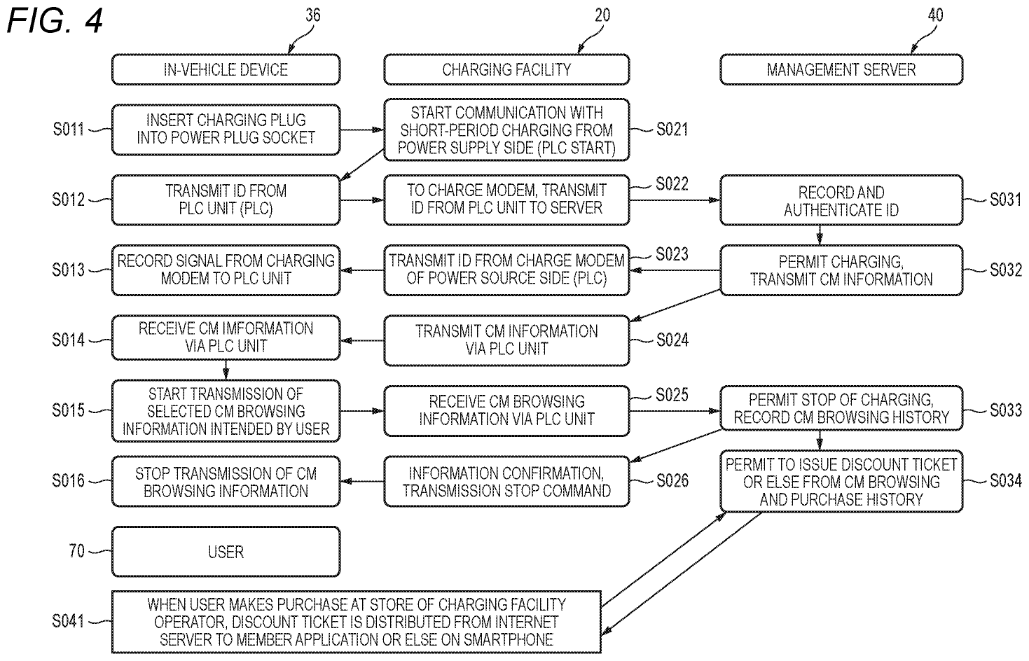

FIG. 4 illustrates an outline of an operation sequence of each part in the communication system of the embodiment. The operation sequence of FIG. 4 will be described below.

The user of the vehicle 30 parks the vehicle 30 in a parking lot where the charging facility 20 is installed and performs an operation for charging preparation (S011). That is, the user inserts a charging plug at the tip of the charging cable 60 provided in the vehicle 30 into the power plug socket 24.

The charger control unit 23 of the charging facility 20 performs a first process (S021) after confirming connection of the charging cable 60 to the power plug socket 24. That is, in order to enable power line communication, the power from a supply side power source 21 is supplied to the in-vehicle device 36 side via the charging cable 60 for a short period of time (for example, thirty seconds) and power line communication is started using the charging modem 22.

When the in-vehicle control unit 33 of the in-vehicle device 36 monitors the status of the PLC unit 34 and detects that the power line communication with the charging facility 20 has become possible, the vehicle ID 37 assigned to itself is transmitted by power line communication (S012).

The charger control unit 23 of the charging facility 20 acquires the vehicle ID 37 transmitted from the in-vehicle device 36 from the charging modem 22 and transmits the ID to the management server 40 (S022).

The management server 40 records the information of the vehicle ID 37 input from the charger control unit 23 and executes the authentication (S031). When the management server 40 is successfully authenticated, that is, when the vehicle ID 37 associated with a registered member user is input from the charging facility 20, the management server 40 permits the charging facility 20 of the transmission source to charge, and further starts transmitting CM information (S032).

When the charger control unit 23 of the charging facility 20 detects the charging permission from the management server 40, continuous power supply from the supply side power source 21 to the charging cable 60, that is, the main charging is started, and the charge authentication ID 22a of the charging modem 22 is transmitted by power line communication (S023).

The in-vehicle control unit 33 of the in-vehicle device 36 acquires and records the charge authentication ID 22a sent from the charging modem 22 of the charging facility 20 via the PLC unit 34 (S013).

After completing the transmission of the charge authentication ID 22a, the charger control unit 23 of the charging facility 20 starts transmitting the CM information input from the management server 40 to the charging cable 60 by power line communication using the charging modem 22 (S024).

The in-vehicle control unit 33 of the in-vehicle device 36 acquires the CM information transmitted from the charging modem 22 of the charging facility 20 via the PLC unit 34 (S014).

For example, after displaying a title list of the received CM information on a screen, the in-vehicle control unit 33 of the in-vehicle device 36 accepts a user's input operation and reproduces specific CM information intentionally selected by the user from the list. The in-vehicle control unit 33 starts transmitting “CM browsing information” representing specific CM information selected by the user by using the PLC unit 34 (S015). Each time the user performs an operation such as selection, the in-vehicle control unit 33 transmits “CM browsing information” indicating the operation content.

The charger control unit 23 of the charging facility 20 acquires the “CM browsing information” transmitted from the in-vehicle device 36 via the charging modem 22 and transmits the “CM browsing information” to the management server 40 (S025).

The management server 40 acquires the “CM browsing information” input from the charger control unit 23 of the charging facility 20 and figure out the current user's browsing status, and then for example, when it is detected that a specific condition is met, such as when playback is continued for a certain period of time, the “CM browsing information” is recorded as the history in association with the charging facility 20, the vehicle ID 37, and the specific user during the charging process (S033). The management server 40 permits the charging of the corresponding charging facility 20 to be stopped.

When the charger control unit 23 of the charging facility 20 receives the charge stop permission from the management server 40, the charger control unit 23 recognizes that the history update of the CM browsing information is completed and sends a transmission stop command to the in-vehicle device 36 from the charging modem 22 (S026).

When the PLC unit 34 receives the transmission stop command from the charging facility 20, the in-vehicle control unit 33 of the in-vehicle device 36 stops the transmission operation of the “CM browsing information”.

On the other hand, a user 70 can access the management server 40 on the Internet by using their own smartphone 50 or can communicate with the in-vehicle control unit 33 of the in-vehicle device 36 by the communication function of Wi-Fi.

In particular, when the member application 51 prepared in advance is installed in the smartphone 50, the user 70 can register the user 70 themselves as a member in the management server 40 by operating the member application 51. The member application 51 can acquire the charge authentication ID 22a from the in-vehicle control unit 33.

The management server 40 manages information such as CM browsing history and product purchase history for each registered member user. Then, when the CM browsing history, the purchase history of a product, and the like satisfy the predetermined conditions, the user is permitted to issue the benefits such as a discount coupon (S034).

When the user 70 purchases a product as a member at the store 10 operated by the business operator that installed the charging facility 20, the smartphone 50 can receive distribution of the benefits such as a discount coupon from the management server 40 via the member application 51 (S041).

### Operation when Charging

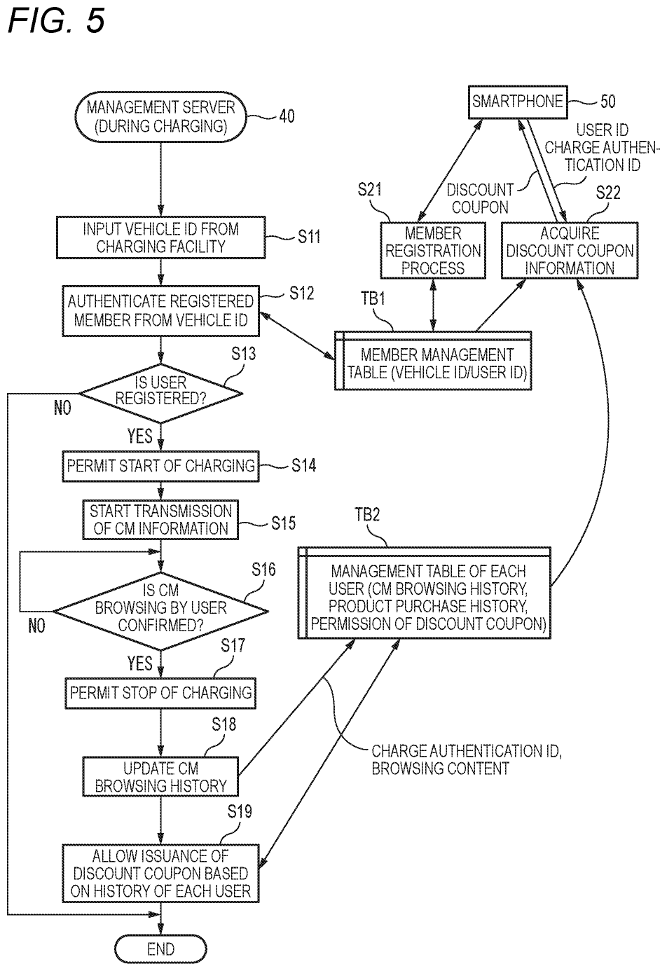

FIG. 5 illustrates a management server operation during charging and operations associated therewith.

In the communication system of the embodiment, the management server 40 which manages members has management tables TB1 and TB2 as databases, as illustrated in FIG. 5.

The management table TB1 holds information for associating the vehicle ID and the user ID with respect to the registered members. When a new user who wants to become a member accesses the management server 40 using the member application 51 built into the smartphone 50 in advance, the user ID can be registered by a member registration process (S21) executed by the management server 40. Since each user can wirelessly connect the smartphone 50 to the in-vehicle control unit 33 using Wi-Fi, the member application 51 on the smartphone 50 can acquire the vehicle ID 37 from the in-vehicle control unit 33. The management server 40 acquires the vehicle ID 37 from the member application 51 and registers the ID in the management table TB1.

The management table TB2 on the management server 40 can hold and manage various information for each registered member. Specifically, the management table TB2 manages information on the CM browsing history of the corresponding user, information on the product purchase history, and the like. Information for permitting the issuance of benefits such as discount coupons can be managed for each user.

When each user attempts to charge the vehicle 30 using the charging facility 20, the management server 40 operates as shown below.

First, in Step S11, the management server 40 inputs information of the vehicle ID 37 from the charger control unit 23 of the charging facility 20. The vehicle ID 37 is included in information transmitted by the in-vehicle device 36 to the charging facility 20 by the power line communication using the charging cable 60.

The management server 40 refers to the management table TB1 using the vehicle ID 37 input in S11 and authenticates whether the corresponding member exists (S12). When there is a member corresponding to the vehicle ID 37 input in S11, the process proceeds from S13 to S14 and the management server 40 permits the charging facility 20 to start charging. The management server 40 starts transmitting the CM information prepared in advance in S15 next.

In the present embodiment, it is assumed that the charging facility 20 charges the vehicle 30 for free to the registered members. However, users other than members may also be configured to be able to use the charging facility 20 for a fee, for example, by paying cash or paying electronic money.

When the management server 40 confirms the input of the CM browsing information sent from a transmission destination user in S16 after starting the transmission of the CM information, the management server 40 permits the charging facility 20 to stop charging in

S17 next. The management server 40 updates the contents of the CM browsing history on the management table TB2 by using the latest CM browsing information sent from the transmission destination user. The user ID of the update target history can be specified based on the vehicle ID 37 input in S11 and the contents of the management table TB1. The contents of the CM browsing history include the charge authentication ID 22a sent from the charging facility 20 which has actually performed charging and the CM browsing information.

Every time each member user charges at the charging facility 20 and every time the member user purchases a product at the store 10, the management server 40 identifies whether the history of the user in the management table TB2 satisfies a predetermined condition, and then issuance of discount coupons is permitted when the condition is met (S19).

For example, the same member user is allowed to issue a discount coupon when the number of times the charging facility 20 is used and the number of times the product is purchased at the store 10 exceeds a certain number in a month. As a result, the same user can be promoted the behavior of using both the charging facility 20 and the store 10. Thus, when the charging facility 20 and the store 10 are operated by the same business operator, the business operator can attract the same user and the charging facility 20 and the store 10 can be operated efficiently. A user who frequently uses the charging facility 20 and the store 10 can enjoy profits together with the business operator because they can obtain benefits such as discount coupons.

For example, a discount coupon which can be used when purchasing a product may be issued based only on the latest CM browsing information regardless of the past history. That is, a discount coupon may be issued to a member user who has charged using the charging facility 20 and who has been able to make it possible to acquire the browsing information based on the transmitted CM information.

A member user who intends to purchase a product at the store 10 can obtain a discount coupon by accessing the management server 40 from the member application 51 using their smartphone 50. Here, the management server 40 authenticates that the user is a member from the management table TB1 in the process of Step S22. The management server 40 identifies the management table TB2 to be referred to from the user ID, and after confirming that the charge authentication ID 22a in the CM browsing history in the management table TB2 and the charge authentication ID sent from the smartphone 50 match, the discount coupon is issued when the issuance of the discount coupon is permitted. As a result, the smartphone 50 of the user can acquire the discount coupon information.

### Operation at the time of Product Price Settlement

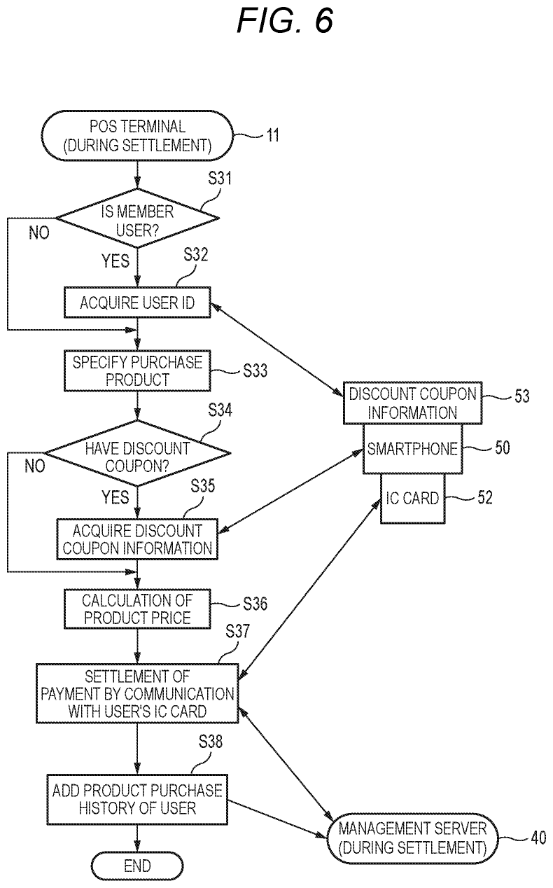

When a user who is a member purchases a product at the store 10, the POS terminal 11 operates as illustrated in FIG. 6 in order to settle the product price.

In the example illustrated in FIG. 6, it is assumed that a user who makes the payment has the smartphone 50 incorporating the member application 51 and an IC card 52 charged with electronic money more than the required price. The IC card 52 is a card device which uses a non-contact communication technology such as FeliCa (registered trademark), and by charging electronic money in advance, the electronic money can be used for payment.

The IC card 52 may be an IC card incorporated in the smartphone 50, such as “Osaifu-Keitai”, or an IC card independent of the smartphone 50. The POS terminal 11 is provided with a non-contact IC card reader having a function of communicating with the IC card 52 in order to enable payment by electronic money.

When a clerk operates the POS terminal 11 at a cash register of the store 10, the POS terminal 11 identifies in S31 whether the user who purchases the product is a member.

When the user is a member, the smartphone 50 and the POS terminal 11 directly perform wireless communication, or the smartphone 50 and the POS terminal 11 communicate with each other via the management server 40, and then the POS terminal 11 acquires the user ID (S32).

At the cash register of the store 10, the clerk operates the POS terminal 11, in such a manner that, for example, the POS terminal 11 identifies the product to be purchased by reading a barcode attached to a target product with a barcode reader connected to the POS terminal 11 and also identifies the price.

It is confirmed before the payment of the price whether the smartphone 50 of the user who purchases the product holds a discount coupon information 53 acquired from the management server 40. When the smartphone 50 holds the discount coupon information 53, the clerk operates the POS terminal 11 to proceed from S34 to S35 and the POS terminal 11 reads the discount coupon information 53 from the smart phone 50.

The POS terminal 11 calculates the price of the product specified in S33 in S36. When the discount coupon information 53 is acquired in S35, the product price reflecting the discount is calculated.

The POS terminal 11 uses a non-contact IC card reader connected to the POS terminal 11 to communicate with the user's IC card 52 and uses the electronic money charged in the IC card 52 to settle the product price (S37). Information necessary for settlement of the product price is exchanged by communication between the POS terminal 11 and the management server 40.

The POS terminal 11 transmits the information necessary for adding the history of the product purchase of the member user now to the management server 40 (S38). For example, information such as the user ID, the purchase date and time, the product number, the payment price, and whether a discount coupon is used is transmitted.

In the example illustrated in FIG. 4, it is assumed that the in-vehicle device 36 receives the charge authentication ID 22a transmitted by the charging facility 20 in S023 at the time of charging and transfers it to the smartphone 50. However, the charge authentication ID 22a may be transmitted directly from the charging facility 20 or the management server 40 to the smartphone 50.

In the example illustrated in FIG. 6, it is assumed that the product price is settled using the electronic money charged in advance in the IC card 52. However, it is also assumed that a debit card or a credit card will be used instead of the IC card 52. For communication between the POS terminal 11 and the IC card 52 or the smartphone 50, it is conceivable to use, for example, a QR code (registered trademark) instead of near field communication (NFC).

For example, in the example illustrated in FIG. 2, it is assumed that the charging facility 20 transmits CM information to the in-vehicle device 36 at the time of charging. However, instead of CM information, it is assumed that information such as a questionnaire useful for soliciting members and sales promotion is transmitted and the results of the questionnaire are collected as CM browsing information.

### Advantages of Communication System

In the above-described communication system, when charging the vehicle 30 using the charging facility 20, by performing power line communication via the charging cable 60, it becomes possible to transmit information useful for efficiently operating both the charging facility 20 and the store 10. In particular, by delivering advertisements and the like and making the users watch them during the time-consuming charging operation, it can be useful for sales promotion of products and the like in the store 10. By collecting the CM browsing information, it becomes easy to figure out the tendency of each user's preference.

As illustrated in FIG. 5, since the vehicle ID and the user ID are linked and managed by the management table TB1, it is possible to manage history information by associating a user who has charged using the charging facility 20 with a user who purchases a product at the store 10. In particular, since the vehicle ID 37 is transmitted from the in-vehicle device 36 to the charging facility 20 at the time of charging as illustrated in FIG. 2, the management server 40 can surely figure out the charged vehicle and the member user. Since the charging facility 20 transmits the charge authentication ID 22a to the in-vehicle device 36 at the time of charging, the charge authentication ID 22a can be retained as a charge record by the user's smartphone 50 or the like. Therefore, by confirming the user ID and charge authentication ID 22a on the smartphone 50 when the management server 40 authenticates the user, it becomes possible to reliably distinguish between the user who has performed charging using the charging facility 20 and the others.

Based on the history of each member user registered in the management table TB2, the management server 40 issues a discount coupon in S22 as illustrated in FIG. 5. Therefore, it is possible to give a benefit limited to a member user who actually uses the charging facility 20 repeatedly and a member user who frequently purchases products at the store 10. As a result, it is possible to promote the use of the charging facility 20 and the purchase of products at the store 10 by each member user, and thus a common business operator who operates the charging facility 20 and the store 10 can attract member users and expand profits. Each member user can obtain benefits by using both the charging facility 20 and the store 10.

According to a communication system of the embodiment, a charging facility (20) which can be connected to a vehicle (30), a management server (40) which can communicate with the charging facility, and a payment terminal (POS terminal 11) which is installed in a store (10) or the like related to the charging facility and can communicate with the management server.

The communication system includes a first function (management table TB1) of managing first management information indicating correspondence between a vehicle ID (37) assigned to each vehicle and a user ID assigned to each user who uses each vehicle by the management server,

a second function (charger control unit 23, 5022) of acquiring the vehicle ID transmitted by the vehicle with the charging facility and transmitting it to the management server when a user of a vehicle performs a charging operation on the vehicle at the charging facility,

a third function (S032, S11 to S14) of permitting start of charging of the charging facility when the management server succeeds in user authentication (S031) based on the vehicle ID received from the charging facility and the first management information,

a fourth function (charging modem 22, S023) of transmitting a charge authentication ID (22a) to a vehicle (in-vehicle device 36) to be charged or a mobile terminal (smartphone 50) owned by the corresponding user after the charging facility starts charging, and

a fifth function (management table TB2, S22, S034) of identifying presence of at least charging history with the management server by acquiring the charge authentication ID transmitted from the mobile terminal of the corresponding user with the payment terminal or the management server when payment of a fee associated with a consumption behavior of each user is made on the payment terminal.

According to the communication system of the configuration described above, for example, it is possible to distinguish whether a user who charged a vehicle using a specific charging facility has used the charging facility in the authentication when the user performs a consumption behavior such as purchasing a product at a store managed by the same business operator as the charging facility. Therefore, for example, it is possible to generate information which associates a user who uses the charging facility with the type of product purchased by the user. Therefore, a common business operator who manages both the charging facility and the store creates special added value based on the relationship between the use of the charging facility and the purchase of a product at the store. As a result, it will be possible to operate the operations of the charging facility and store efficiently. A vehicle user who uses both the charging facility and the store will be able to get benefits from the added value created by the business operator.

The management server may include a sixth function (S22) of issuing coupon information (discount coupon information 53) which grants a benefit for a fee associated with a user's consumption behavior when a result identified by the fifth function satisfies a predetermined condition.

According to the communication system having the configuration described above, for example, when a specific user who charged a vehicle using a charging facility purchases a product at a store managed by the same business operator as the charging facility, coupon information which discounts the price of the product can be used. In other words, it is expected that users will use both the charging facility and the store managed by the same business operator for the purpose of obtaining benefits, and thus the business operator will be able to attract the same users and enjoy the benefits of installing the charging facility alongside the store.

The charging facility may include a seventh function (S15, S024, S032) of transmitting advertisement information via a charging electric cable (charging cable 60) during a charging operation for each vehicle and an eighth function (S16, S18, management table TB2) of managing browsing history related to information selected by the user of the vehicle to be charged in the transmitted advertisement information, and the sixth function of the management server may issue (S034, S041) the coupon information according to the browsing history acquired based on the eighth function.

According to the communication system having the configuration described above, during the spare time waiting for the completion of charging, a user who charged a vehicle using a charging facility can browse the advertisement information provided by the charging facility side and acquire information such as a product that the user needs. The user can acquire coupon information according to the browsing history of the advertisement information. A common business operator who manages both the charging facility and the store can figure out trends of a product or the like that the user is interested in based on the information in the browsing history of the user. As a result, the system can be useful for efficient store management.

The management server may include a ninth function (S38, management table TB2) of managing consumption behavior history of the corresponding user when payment of a fee associated with a consumption behavior of each user is performed on the payment terminal, and

the sixth function of the management server may issue (S22, S034, S041) the coupon information according to the consumption behavior history acquired by the ninth function.

According to the communication system of the configuration described above, the coupon information can be used to give benefits to a specific user who frequently uses the charging facility and purchases a product at the store managed by the same business operator as the charging facility. Therefore, it is possible to promote the attraction of users.

According to a communication control method of the embodiment, a communication system which includes a charging facility (20) which can be connected to a vehicle, a management server (40) which can communicate with the charging facility, and a payment terminal (POS terminal 11) which is installed in a store (10) or the like related to the charging facility and can communicate with the management server is used.

The communication control method manages first management information (management table TB1) indicating correspondence between a vehicle ID assigned to each vehicle and a user ID assigned to each user who uses each vehicle by the management server,

acquires the vehicle ID transmitted by the vehicle with the charging facility and transmits it to the management server when a user of an arbitrary vehicle performs a charging operation on the vehicle at the charging facility (S022, S11),

permits start of charging of the charging facility when the management server succeeds in user authentication (S031) based on the vehicle ID received from the charging facility and the first management information (S032, S14),

transmits a charge authentication ID (22a) to a vehicle to be charged or a mobile terminal owned by the corresponding user after the charging facility starts charging (S023), and

identifies presence of at least charging history with the management server by acquiring the charge authentication ID transmitted from the mobile terminal of the corresponding user with the payment terminal or the management server when payment of a fee associated with a consumption behavior of each user is made on the payment terminal (S22, S034).

According to the communication control method of the configuration described above, for example, it is possible to distinguish whether a user who charged a vehicle using a specific charging facility has used the charging facility in the authentication when the user performs a consumption behavior such as purchasing a product at a store managed by the same business operator as the charging facility. Therefore, for example, it is possible to generate information which associates a user who uses the charging facility with the type of product purchased by the user. Therefore, a common business operator who manages both the charging facility and the store creates special added value based on the relationship between the use of the charging facility and the purchase of a product at the store. As a result, it will be possible to operate the operations of the charging facility and store efficiently. A vehicle user who uses both the charging facility and the store will be able to get benefits from the added value created by the business operator.

According to the communication system and communication control method of the embodiment, it is possible to build a new business model which is useful for managing the consumption behavior associated with the charging operation by a user who uses an electric vehicle or the like.

What is claimed is:

1. A communication system which includes a charging facility which can be connected to a vehicle, a management server which can communicate with the charging facility, and a payment terminal which is installed in a store or the like related to the charging facility and can communicate with the management server, the system comprising:
a first function of managing first management information indicating correspondence between a vehicle ID assigned to each vehicle and a user ID assigned to each user who uses each vehicle by the management server;
a second function of acquiring the vehicle ID transmitted by the vehicle with the charging facility and transmitting it to the management server when a user of a vehicle performs a charging operation on the vehicle at the charging facility;
a third function of permitting start of charging of the charging facility when the management server succeeds in user authentication based on the vehicle ID received from the charging facility and the first management information;
a fourth function of transmitting a charge authentication ID to a vehicle to be charged or a mobile terminal owned by the corresponding user after the charging facility starts charging; and
a fifth function of identifying presence of at least charging history with the management server by acquiring the charge authentication ID transmitted from the mobile terminal of the corresponding user with the payment terminal or the management server when payment of a fee associated with a consumption behavior of each user is made on the payment terminal.

2. The communication system according to claim 1, wherein
the management server includes a sixth function of issuing coupon information which grants a benefit for a fee associated with a user's consumption behavior when a result identified by the fifth function satisfies a predetermined condition.

3. The communication system according to claim 2, wherein
the charging facility includes a seventh function of transmitting advertisement information via a charging electric cable during a charging operation for each vehicle and an eighth function of managing browsing history related to information selected by the user of the vehicle to be charged in the transmitted advertisement information, and the sixth function of the management server issues the coupon information according to the browsing history acquired based on the eighth function.

4. The communication system according to claim 2, wherein
the management server includes a ninth function of managing consumption behavior history of the corresponding user when payment of a fee associated with a consumption behavior of each user is performed on the payment terminal, and
the sixth function of the management server issues the coupon information according to the consumption behavior history acquired by the ninth function.

5. A communication control method which uses a communication system which includes a charging facility which can be connected to a vehicle, a management server which can communicate with the charging facility, and a payment terminal which is installed in a store or the like related to the charging facility and can communicate with the management server, the method comprising:
managing first management information indicating correspondence between a vehicle ID assigned to each vehicle and a user ID assigned to each user who uses each vehicle by the management server;
acquiring the vehicle ID transmitted by the vehicle with the charging facility and transmitting it to the management server when a user of a vehicle performs a charging operation on the vehicle at the charging facility;
permitting start of charging of the charging facility when the management server succeeds in user authentication based on the vehicle ID received from the charging facility and the first management information;
transmitting a charge authentication ID to a vehicle to be charged or a mobile terminal owned by the corresponding user after the charging facility starts charging; and
identifying presence of at least charging history with the management server by acquiring the charge authentication ID transmitted from the mobile terminal of the corresponding user with the payment terminal or the management server when payment of a fee associated with a consumption behavior of each user is made on the payment terminal.
